(19) United States
(12) Patent Application Publication
(10) Pub. No.: US 2025/0148444 A1
(43) Pub. Date: May 8, 2025

(54) ACKNOWLEDGEMENT PROCESS FOR MESSAGE TRANSMISSIONS TO CONNECTABLE PROCESSING TERMINALS FOR POINT-OF-SALE DEVICES

(71) Applicant: PAYPAL, INC., San Jose, CA (US)

(72) Inventor: Daniel Harbor, San Jose, CA (US)

(21) Appl. No.: 18/502,403

(22) Filed: Nov. 6, 2023

(51) Int. Cl. G06Q 20/20

(52) U.S. Cl. CPC G06Q 20/202

(57) ABSTRACT

There are provided systems and methods for an acknowledgement process for message transmissions to connectable processing terminals for point-of-sale (POS) devices. A user may engage in a transaction with a merchant at a POS device, such as a purchase of items from a merchant at a physical merchant location and using payment terminals with the POS device. An online transaction processor may provide an acknowledgement process to determine if the payment terminal is online and receiving communications so that the user may view transaction details and complete transaction processing. This may be done through lookup of a previous connection of the payment terminal over a cloud computing system with the transaction processor and transmission of a request for acknowledgement over that connection. If the payment terminal responds with an acknowledgement, the transaction processor may then notify the POS device that data processing may proceed.

### TECHNICAL FIELD

The present application generally relates to point-of-sale (POS) devices and connectable terminal devices and more particularly to an acknowledgement process for online status and messaging capability of terminal devices on POS device request.

### BACKGROUND

Users may utilize online transaction processors for processing payments between different entities through device applications and digital accounts. These online transaction processors may also provide customers and merchants with software and hardware for in-person transaction processing and use at merchant locations. For example, mobile applications and/or payment cards may be provided to customers, while merchants may utilize payment processing terminals, software applications, and/or software development kits (SDKs) with POS devices for payment processing using transaction processing and payment networks, servers, and the like for the transaction processor. These payment terminals and other physical devices connectable with POS devices may include components and modules for local wireless exchanges of data and transaction processing, as well as card readers and the like (e.g., NFC, EMV chip, and/or magnetic stripe readers).

However, use of these terminal devices requires that the terminal devices are turned on, have power, are online, and/or are connected to the POS device for data exchange. In the event that a terminal device does not have power or cannot connect to a network (either directly or via a POS or other device), the payment terminal may not be usable. In conventional computing systems and architectures, there is not currently a process to ensure that a payment terminal that was previously connected to a POS device is still online and usable to process data from customers. As such, merchants may initiate data processing that may require use of a terminal device with a POS device, but the terminal device may not be receiving messages from the POS device and/or backend data processing servers. This causes a disconnect in data transmissions and loss of messages and communications, resulting in an inability to conduct or finalize a transaction. Thus, it is desirable for online transaction processors to provide merchants with real-time detection of payment terminal status and capabilities to efficiently process messages and data without message transmission loss.

### BRIEF DESCRIPTION OF THE DRAWINGS

FIG. 1 is a block diagram of a networked system suitable for implementing the processes described herein, according to an embodiment;

FIGS. 2A-2C are exemplary system environments of different devices and servers interacting to provide an acknowledgement process of receipt of message transmissions and message processing, according to an embodiment;

FIG. 3 is an exemplary diagram of exchanged application programming interface (API) calls and message transmissions for acknowledging a message transmission by a terminal device with a backend server for notifying a POS or other device of the terminal device's status, according to an embodiment;

FIG. 4 is a flowchart of an exemplary process for an acknowledgement process for message transmissions to connectable processing terminals for POS devices, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an acknowledgement process for message transmissions to connectable processing terminals for POS devices. Systems suitable for practicing methods of the present disclosure are also provided.

A user may utilize a digital account, payment card, and/or other funding source to process payments through a payment and/or transaction processor network for an online transaction processor or other entity on the network. The transaction processor may include an integration with the electronic payment network (e.g., for payment cards, tokens, and the like) that allows for data exchange and communications with merchant POS devices, as well as payment terminal devices of the transaction processor and/or merchants. Further, the transaction processor and network may provide and/or utilize data communications and backend processing server devices that provide for interaction with frontend merchant, POS, and/or payment terminal processing devices that process transactions, including in-person transactions at merchant locations via payment card and/or contactless payments including near field communications (NFC), radio frequency identification (RFID) fields and communications, Bluetooth or WiFi communications, infrared scanners and/or communications, EMV chip reader, magnetic stripes and/or emulation readers, and other in-person and local data transfers.

However, for customers and merchants to utilize such payment mechanisms and networks, payment terminal devices are required to be powered, online, and connected to a network and/or POS device to facilitate data transfers and communications. Conventionally, the merchant may charge the device and power the device on, such as at the start of the day or when rotating in a fresh or charged device. The terminal device may initially connect to a network and/or POS device, but may then lose reception, connectivity, and/or power. When this occurs, the merchant using the device may be unaware of such issue, and therefore may continue with data processing with their POS device as if the terminal device was still online and receiving messages, which causes loss of messages, time during reconnect of the terminal device, and/or customer frustration and wasted time when their input to the terminal device is not sent, received by the POS device and/or backend processor server, and processed.

As such, the transaction processor may implement an acknowledgement process whereby, upon receipt of a request to utilize the payment terminal device, one or more backend servers initiate a process to receive an acknowledgement from the payment terminal device. This process may utilize a previous connection identifier (ID) and connection established with the terminal device when that terminal device is first used and/or connected during a use session, such as one established over a bidirectional connection using a cloud computing system associated with the transaction processor. The bidirectional connection may correspond to WebSocket (e.g., a full-duplex bidirectional connection protocol) or other connection protocol that provides bidirectional, duplex, or two-way communications over a single Transmission Control Protocol (TCP) connection or other similar connection. As such, bidirectional connections may be used over certain cloud computing environments and the like to provide bidirectional communications between devices, servers, and the like.

This connection and connection ID may be used to identify a network address or other endpoint ID used to communicate with the terminal device so that an acknowledgement request or other message requesting acknowledgement may be sent to the terminal device. When sending this message, a new ID, e.g., a context ID, may be specifically established for the POS device's request and/or acknowledgement request, and may be stored so that a status of the terminal device for the particular context in which the terminal device is being used may be determined at a later time. The context ID may be stored to a database, data store or lake, centralized or distributed data repository, cache, cloud storage system (e.g., DynamoDBs for Amazon Web Services (AWS)® or the like), or similar data storage system that is accessible by the transaction processor. The transaction processor may then listen, monitor, poll, and/or check the database to determine whether the terminal device is responsive, which may then be used to determine and notify the POS device of the status.

For example, a user may desire to purchase items at physical merchant locations via in-person transactions, which may be facilitated by merchants using POS devices and connectable payment terminal devices (e.g., card readers, EMV chip or magnetic stripe scanners, NFC readers/transceivers, QR code scanners, devices for interaction with mobile smart phones and applications, etc.). Selection of one or more items in an in-person transaction at a physical merchant location may require a payment instrument from the user for electronic transaction processing, which may be provided via a payment card and/or short-range wireless communications (e.g., contactless payments via NFC, RFID, etc.). In some embodiments, a user may pay for one or more transactions using a digital wallet that is set up and configured to utilize contactless payment terminals and devices with a payment network, where the digital wallet includes an account with an online service provider or other transaction processor. A digital account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. However, payment cards may also include chips and/or embedded/encoded data that is linked to accounts, includes tokens or data for token generation, and the like.

When establishing an account for payments and transaction processing, the user may also be required to provide financial information, including digital account (e.g., credit/debit card) information, bank account information, gift card information, benefits/incentives, and/or financial investments. Account creation may also be used to establish account funds and/or values, such as by transferring money into the account and/or establishing a credit limit and corresponding credit value that is available to the account and/or card. The service provider may provide computing services to send, store, and receive money, process financial instruments, and/or provide transaction histories. The service provider may also provide for tokenization of data for transaction processing. The application or website of the service provider, such as PayPal® or other online payment provider, may provide payments and the other transaction processing services. Moreover, the digital account may be utilized through one or more mobile applications for mobile devices or other software applications.

In order to process and/or pay for a transaction (e.g., a transfer or payment to another user, merchant, or other entity), the user may provide the digital account or funding source at the POS device, where data from the mobile application or payment card may be read, entered, or otherwise input to a payment terminal device that interacts with the POS device to facilitate payment processing. For example, with in-person payments through contactless payment terminals and a payment card or mobile device, an identifier and/or digital token or other data may authorize and/or authenticate the user for their digital wallet use and/or a payment instrument (e.g., the account with the online transaction processor, credit line with a credit card provider, etc.). The data may be stored by and/or transferred using one or more storage mediums and/or wireless transceivers, such as an NFC/RFID component, fob, passive or active antenna, etc., a magnetic stripe or an EMV chip, a displayable code or data, or the like.

Payment terminal devices and other similar terminal devices may correspond to handheld and/or small device stands where customers may view certain transaction data, make selections (e.g., confirm a transaction total, enter loyalty information or coupons, etc.), and input payment data, such as digital tokens, payment card chips/magnetic stripes, and the like. These terminals provide customers with information from merchant POS devices so that the customer and merchant may view data in a convenient manner between two interacting devices, and further provide customers with discretion or secrecy when entering certain data, such as personal data (e.g., a phone number for a loyalty account), PINs, or the like, that may be necessary for transaction processing confirmation, authentication, and/or security. Further, these devices allow for secure reading of payment data and transmission to a backend server and/or processor of the transaction processor for payment processing.

Initially on startup and/or use of a payment terminal device, the payment terminal device may connect to the backend of the transaction processor over a cloud computing infrastructure and/or system, such as using a bidirectional connection or similar facilitated connection via a cloud computing system (e.g., AWS or the like) used by the transaction processor. A cloud computing system may be used by the transaction processor with merchant POS devices and payment terminal devices to manage many different bidirectional connections with such devices, as well as store and manage data during interactions with such devices. In this regard, establishment of this connection generates a connection ID for the bidirectional connection established using the cloud computing system, which may be stored in an accessible database and used to identify that connection and/or correspond to a network address of the terminal device for communication transmission. As such, the connection ID allows for identification of the device and a corresponding connection with the device from the initial network connection, handshake, and establishment of the connection.

Thus, when the merchant or other entity wanting to use the terminal device first initiates a request to use the terminal device using a bidirectional connection over the cloud computing environment, such as via a POS device of the merchant, a request may be sent from that POS or other device to the transaction processor (e.g., over the Internet or other network between the devices). This request may correspond to a transaction processing request, such as an API call and/or request having a data load including transaction data for a transaction being processed at the POS device. The transaction processor or other online service provider may receive the request and create an ID, such as a “context” ID, that uniquely identifies the request and particular context of the API call and request. This context ID may be stored to a database with the transaction data or other data load for the request, the POS device ID, merchant ID, and/or other data. For example, for a particular transaction, a unique context ID (e.g., a universally or global unique ID (UUID or GUID)) may be created that uniquely identifies that particular transaction to the transaction processor, and may be provided to other devices to correlate further interactions with that transaction. In other embodiments, other types of computing activities and/or interactions may be identified by a context ID, such as a message requiring a read receipt or acknowledgement, a firmware update request and/or status, and the like.

The transaction processor may then create a message and/or acknowledgement request of a message/communication that is to be transmitted to the payment terminal device. This may be generated using the context ID and may include the context ID and a request or command/process that causes the terminal device to respond to the transaction processor with an acknowledgement of receipt of the request and/or message. The request and/or message may be transmitted to the terminal device using the bidirectional connection that was previously established and currently open with the terminal device over the cloud computing environment, such as a bidirectional connection, which may be determined using the connection ID. For example, using the connection ID, a network address retrieved and used for transmitting the request/message to and communicating with the terminal device. Thus, the request/message may be transmitted to the terminal device over the previously established connection using the connection ID and corresponding network addresses generated and stored in the database from the establishment of the connection.

On transmission of the message, the transaction processor may further establish, create, initiate, or otherwise start a process that listens, polls for, tracks, checks, and/or monitors for an incoming message, event, or the like from the terminal device. Monitoring and determining if the message/event is received or detected may be limited to a time period, after which, the transaction processor may determine that such terminal device is unresponsive and therefore facing an issue (e.g., no power, connectivity, Internet, broken or disabled, etc.). Thus, the incoming message or event may correspond to the acknowledgement, which then indicates the status of the terminal device as online and/or receiving and acknowledging messages and requests, thereby identifying the terminal device as “online,” “ready,” or “available.” However, if not received by the end of the time period, the terminal device may be identified as unacknowledged and therefore “offline,” “unknown,” or “unavailable.”

The request/message from the transaction processor may thus cause the payment terminal device, if received, to respond with a message and/or acknowledgement (e.g., via API call) that acknowledges receipt of the request/message from the transaction processor, thereby indicating the terminal device is online and available to receive and/or process data. If received, the terminal device may then respond with the acknowledgement and context ID, which may be provided over the connection and cloud computing system. The acknowledgement may be stored (e.g., in the database, cloud storage, cache, etc.) when received and in association with the context ID so that the acknowledgement may be recorded. The acknowledgement process may monitor for, periodically poll, or otherwise check the database, data store, cache, or other storage that includes a table for the context ID and received messages, acknowledgements, and/or activity using the context ID. The monitoring, polling, or other checking may be performed using a lookup or query for the context ID to determine if the acknowledgement is received and stored. If so, the transaction processor may then respond to the POS device using the context ID that terminal device is online, or otherwise notify and/or update the POS device of the online and available status of the terminal device. However, if the time period ends without the acknowledgement, the transaction processor may, on expiration of the time period, notify, update, and/or provide a status of the terminal device to the POS device that designates the terminal device as offline or unavailable.

In the aforementioned process, environment, and computing and communication architecture, a payment terminal device, such as a card or device reader, is pinged and checked for availability to conduct electronic transaction processing for an in-person transaction with a POS device. As such, the POS device may receive a status update and/or notification of the availability and connectivity of the terminal device when a transaction is entered and/or initiated for processing at the POS device. This allows the POS device to rely on the terminal device to receive payment data and details from a customer or other user on the other end of the transaction from the merchant for the POS device, such as by allowing the user to enter and read a payment card, scan a mobile smart phone and/or connect to the phone to receive/exchange payment data or a token, or otherwise allow for entry of payment data. Further, the POS device may, once online and available, provide information and a payment processing flow to the user, which may be used to show a transaction total and/or items, request the user enter a payment instrument and/or loyalty data and coupons, and/or provide the user with the results of transaction processing. However, if detected as unavailable or offline, the merchant may then rotate a new terminal device in use and connect with the POS device so that time and errors in data processing at the terminal and/or with the user may be reduced, thereby ensure exchange of messages.

In further embodiments, the aforementioned process may also be used in other environments and with other devices and systems requiring status checks and updates, as well as confirmation of availability and/or message receipt and acknowledgement. For example, with firmware updates, a similar process may be used by a device requiring a firmware update that may be initiated by another device and require a backend service provider and/or firmware update service to perform such update. For example, the payment terminal device, in such an embodiment, may correspond to the same or another secondary device requiring a firmware update (e.g., a mobile smart phone, device accessory (e.g., headphones, smart watch, etc.), local router, etc.). Another primary device, such as a user's or merchant's main computing device (e.g., POS device, desktop computer, mobile smart phone, etc.), may initiate the firmware update, but be required to determine the status of the secondary device is online and available, as well as acknowledge the firmware update has been completed.

As such, the process to obtain an acknowledgement and track the status of the secondary device may similarly be used. This may also be used by messaging systems that require or provide an acknowledgement process to messages that have been transmitted between the devices and/or facilitated using a backend server. In such embodiments, the messaging system may be used for emergency messaging services, which may allow for identification of a device availability and confirmation that a message has been received and may also be used for messaging between devices and users that may wish to have message receipt confirmation.

In this manner, a transaction processor or other service provider may check and ensure device connectivity and availability, such that messaging and data processing may be made more reliant and with less interruptions and lost data. This ensures message and data exchange so that data processing may proceed with less errors and likelihood of lost data and/or inputs. Further, the operations provide a faster and more efficient manner of detecting device availability and online status so that customers, merchants, and other users or entities may be ensured of device reliability during data processing. Therefore, a system may provide a coordinated and efficient manner of messaging transmissions and exchange to acknowledge message receipt and device status, resulting in improved electronic processing of transactions.

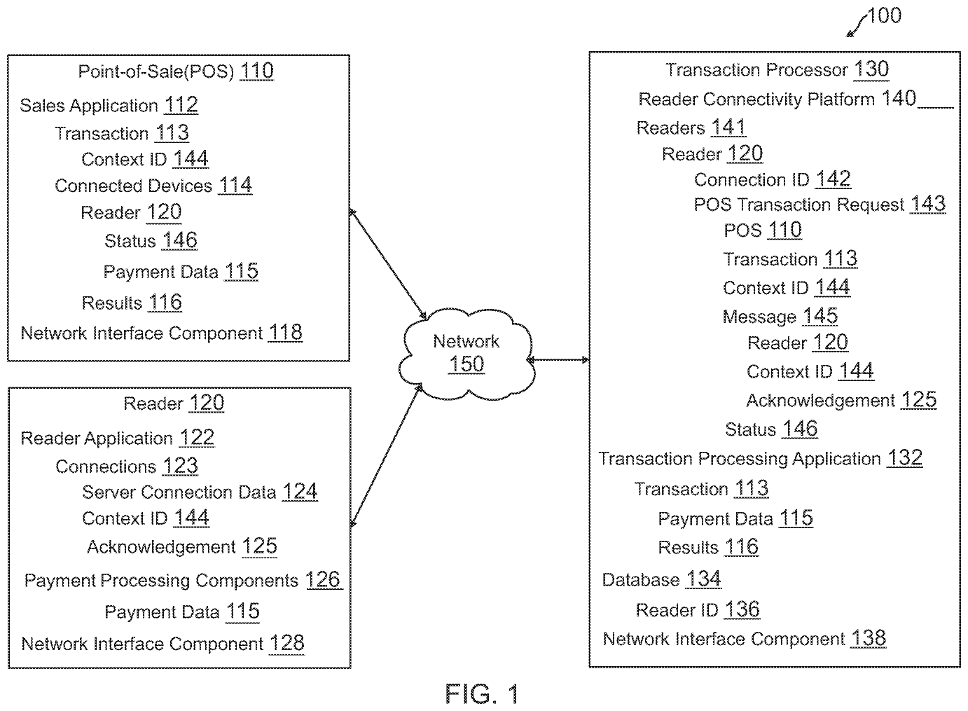

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a point-of-sale (POS) 110, a reader 120, and a transaction processor 130 in communication over a network 150. POS 110 may be used to establish a transaction by a merchant or merchant employee and process a payment for the transaction using reader 120, where reader 120 may facilitate transaction review and acceptance, as well as payment data entry, by a customer or other user. In this regard, when the transaction is processed, the transaction data may be provided over a transaction network, which may be available over network 150 to transaction processor 130. POS 110 may utilize a digital wallet provided by reader 120 to process transactions using payment cards, mobile devices, contactless payment systems, and the like through in-person and/or through wireless communications and communication protocols via reader 120. Transaction processor 130 may provide a process to identify when reader 120 is online or offline, which may be used to provide a status to POS 110.

POS 110, reader 120, and transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

POS 110 may be implemented using any appropriate hardware and software configured for wired and/or wireless communication with user devices (e.g., mobile smart phones, wearable devices, tablets, personal computers, etc.), payment terminals including reader 120, contactless payment transceivers and devices, and/or transaction processor 130 for processing a transaction. POS 110 may correspond to a merchant that processes payments and sales through an executable software application that may utilize a payment network associated with transaction processor 130. In various embodiments, POS 110 may be implemented as a specific merchant register and/or payment processing device, a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing device may function similarly.

POS 110 of FIG. 1 contains a sales application 112 and a network interface component 118. Sales application 112 may correspond to executable processes, procedures, and/or applications with associated hardware. In other embodiments, POS 110 may include additional or different modules having specialized hardware and/or software as required.

Sales application 112 may correspond to one or more processes to execute software modules and associated components of POS 110 to provide features, services, and other operations for a merchant to process transactions at a merchant location, such as a physical storefront, retail location, or the like, using reader 120 to facilitate customer interactions and transaction processor 130 to process payments. In this regard, sales application 112 may correspond to specialized software utilized by a user of POS 110 that may be used to provide a convenient interface to input transaction data and request transaction processing. In some embodiments, sales application 112 may provide a browser process and/or correspond to a browser application that may access a website or application (e.g., mobile application, rich Internet application, or resident software application) that may display one or more user interfaces that allow for transaction processing and interaction with the computing services of reader 120 and transaction processor 130. As such, sales application 112 may correspond to a general browser application configured to retrieve, present, and communicate information over the Internet (e.g., utilize resources on the World Wide Web) or a private network. However, in other embodiments, sales application 112 may include a dedicated application corresponding to a merchant, reader 120, transaction processor 130, or other entity, which may similarly provide such interfaces to utilize transaction processing services via reader 120 and transaction processor 130.

Sales application 112 may be associated with merchant account information, financial information, and/or transaction histories include receipt data. When utilizing sales application 112 with transaction processor 130, sales application 112 may request processing of a transaction 113, such as a payment request and/or data transfer of payment data for payment processing that may be facilitated using reader 120. For example, a payment request for transaction 113 may be generated by POS 110 or other interaction may correspond to utilizing sales application 112 to request, establish, and/or process a transaction for payment. When transaction 113 is generated, a request may be sent to transaction processor 130 to determine a status 146, “wake up,” activate, connection, and/or push or provide transaction data to reader 120. As such, transaction processor 130 may respond with a context ID 144 that may uniquely identify transaction 113 and/or the context of the interaction to process transaction 113 and determine a status of reader 120 during payment processing.

Transaction processor 130 may then perform operations and messaging to determine the status of reader 120, as discussed herein. POS 110 may include a list of connected devices 114, where connected devices 114 identify reader 120 as being connected. Once status 146 of reader 120 has been determined, status 146 may be provided to POS 110 and viewable through sales application 112. If reader 120 is determined to be online and available for payment processing, payment data 115 may be provided by a customer via reader 120. For example, a payment card may be read or scanned, or a token may be transmitted wirelessly, such as through short range wireless communications for contactless payment protocols to reader 120. Sales application 112 may process transaction 113 using payment data 115 with transaction processor 130, which may return results 116 of payment and transaction processing, such as if a payment was approved or declined for transaction 113. Thereafter, sales application 112 may be used to view results 116 of transaction processing and the like via one or more interfaces, as well as print on a receipt, transmit to another device including reader 120, and the like.

In various embodiments, POS 110 includes other applications as may be desired in particular embodiments to provide features to POS 110. For example, the other applications may include security applications for implementing client-side security features, programmatic client applications for interfacing with appropriate APIs over network 150, or other types of applications. The other applications may also include email, texting, voice and IM applications that allow a user to send and receive emails, calls, texts, and other notifications through network 150. In various embodiments, the other applications may include financial applications, such as banking applications.

The other applications may also include location detection applications, which may be used to determine a location, such as a mapping, compass, and/or GPS application, which can include a specialized GPS receiver that determines location information for POS 110. The other applications may include device interface applications and other display modules that may receive input from the user and/or output information to the user. For example, the other applications may contain software programs, executable by a processor, including a graphical user interface (GUI) configured to provide an interface to the user. The other applications may therefore use components of POS 110, such as display devices capable of displaying information to users and other output devices, including speakers.

POS 110 may further include a database, cache, or the like stored on a transitory and/or non-transitory memory of POS 110 or may utilize a cloud-based storage, server database or cache, or other internal or external data storage system, which may store various applications and data and be utilized during execution of various modules of POS 110. The database may include, for example, identifiers such as operating system registry entries, cookies associated with sales application 112 and/or the other applications, identifiers associated with hardware of POS 110, or other appropriate identifiers, such as identifiers used for payment/user/device authentication or identification, which may be communicated as identifying the user/POS 110 to transaction processor 130.

POS 110 includes at least one network interface component 118 adapted to communicate with reader 120, transaction processor 130, and/or other devices and servers over network 150. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Reader 120 may be implemented using any appropriate hardware and software configured for wired and/or wireless communication with user devices, and may connect or be connectable with merchant devices, POS devices and registers including POS 110, the like used for processing a transaction. Reader 120 may be used by a merchant and/or merchant employee that processes payments and sales at a physical merchant location. In various embodiments, reader 120 may be implemented as a personal computer (PC), a payment terminal device with payment processing components, a smart phone, laptop/tablet computer, wristwatch with appropriate computer hardware resources, other type of wearable computing device, and/or other types of computing devices capable of transmitting and/or receiving data. Although only one device is shown, a plurality of device may function similarly.

Reader 120 of FIG. 1 contains a reader application 122 and a network interface component 128. Reader application 122 may correspond to executable processes, procedures, and/or applications with associated hardware. In other embodiments, reader 120 may include additional or different modules having specialized hardware and/or software as required.

Reader application 122 may correspond to one or more processes to execute software modules and associated components of reader 120 to provide features, services, and other operations for payment processing over network 150 with POS 110 and transaction processor 130. Transaction and payment processing may include receiving payment data 115 and the like from customers and other users that are used to process transaction 113 and/or other transactions directly with POS 110 and/or over network 150 with transaction processor 130. In this regard, reader application 122 may correspond to specialized software that may display one or more user interfaces to customers and other users that allow entry of data for payment processing. Reader application 122 may include payment operations, which may be used to process payments with users. For example, the payment operations may be used to receive a transaction to purchase one or more items or services (e.g., data for transaction 113), and present such data to the customer or other user. In this regard, the transaction data may correspond to transaction details that and presented for review and/or approval, such as where POS 110 may provide information for transaction 113 to reader 120 directly or over network 150. In some embodiments, reader application 122 may also facilitate entry of data for transaction 113, such as by receiving item or service input and selection through item scanning, menu or interface selections and input, receipt of a transaction or order from another device or server, and the like. The payment operations may further request payment for the transaction, which may be provided using cash and merchant input, a check and merchant input and/or a check reader, a payment or gift card using a card reader (e.g., magnetic stripe reader, EMV or RFID chip reader, etc.), and/or a contactless payment terminal and component for mobile application payments from mobile devices (e.g., via NFC, RFID, QR code scanning, etc.). Reader application 122 may process a transaction and/or a payment request using payment data from one or more contactless payment devices, terminals, transceivers, or the like, as well as merchant input (e.g., cash or check transactions). The payment operations to enter, receive, and process transaction and payment data may utilize terminal components, short-range transceivers, and/or network interface component 128. Thereafter, reader application 122 may be used to view the results of transaction processing and the like via one or more interfaces, which may include a receipt or other transaction history.

In order to determine a status of reader 120, such as whether reader 120 is active, working, powered, online, and/or available for transaction and payment processing, transaction processor 130 may implement an acknowledgement process that requires acknowledgement of a request or other message sent by transaction processor 130 to reader 120. For example, reader application 122 may initially establish connections 123, which may correspond to one or more connections established on activation, startup, and/or use that facilitate the use of reader 120 with POS 110 and/or other devices for data processing of transactions and/or customers' payment data. Connections 123 may correspond to bidirectional connections, which may be established over a cloud computing system or environment and correspond to a two-way interactive communication session between a client (e.g., application or browser, such as reader application 122) and server (e.g., backend AWS server or other cloud-based server) that may be established via a handshake and negotiated connection protocol for messaging requests and responses. The cloud computing environment may be provided and/or utilized by transaction processor 130 for communication with reader 120 and other readers, payment terminal devices, and the like, for connection creation, maintenance, and logging, including storing and maintaining various connection IDs to identify connections established over the cloud computing environment with different terminal devices and the like.

As such, connections 123 include server connection data 124, which may correspond to a connection, communication channel, bidirectional messaging process, or the like that connects reader 120 with transaction processor 130 and/or the applications and servers of the cloud computing environment used by transaction processor 130. When a request or other message requiring acknowledgement is sent to reader 120 to identify status 146 of reader 120 when processing transaction 113, context ID 144 may be received with the request. If reader 120 is active, online, and available, an acknowledgement 125 may be generated, which may be transmitted back to transaction processor 130 for processing. This process may then cause POS 110 to proceed with transaction processing, where payment data 115 may be processed using payment processing components 126.

In various embodiments, reader 120 includes other applications as may be desired in particular embodiments to provide features to reader 120. For example, the other applications may include security applications for implementing client-side security features, programmatic client applications for interfacing with appropriate application programming interfaces (APIs) over network 150, or other types of applications. In various embodiments, the other applications may include financial applications, such as banking applications and the like for payment processing. The other applications may include device interface applications and other display modules that may receive input from the user and/or output information to the user. For example, the other applications may contain software programs, executable by a processor, including a graphical user interface (GUI) configured to provide an interface to the user. The other applications may therefore use terminal components of reader 120, such as a display capable of displaying information to users and other output devices, including speakers.

Payment processing components 126 of reader 120 may be used to provide additional functionality and assist in transaction and payment processing, as well as digital receipt providing including transmitting digital receipts locally over short-range wireless communications without using or requiring contact identifiers and the like from users. In this regard, payment processing components 126 may include data readers, code scanners, transceivers, and the like, which may be configured to read data from payment cards, gift cards, mobile devices, key fobs, and the like. The data read from such devices may include payment data, and therefore data readers may include magnetic stripe readers, EMV chip readers, NFC card of fob device readers, and the like. Payment processing components 126 further includes a display, which may be configured to output and display data to the user and/or merchant. The display may be used during transaction processing to display transaction processing input, results, and the like. This may include transaction details for review and confirmation, prompts for payment data input, and the like. In this regard, payment processing components 126 further including input components, such as buttons, a keyboard, a mouse, a touch screen interface, and the like, which enable the aforementioned inputs and selections to be made.

Reader 120 includes a short-range transceiver adapted to communicate with POS 110 and/or other nearby devices, transceivers, and/or components through short-range wireless signaling and communications including NFC communications, RFID communications, Bluetooth, WiFi, infrared scanners and/or communicators, and the like. In various embodiments, the short-range transceiver may correspond to microwave, RF, infrared, Bluetooth, and NFC devices and components. Reader 120 may also communicate and/or read data from quick response (QR) codes, barcodes, and other scannable and/or readable codes for short-range wireless exchanges of data, which may utilize a display component, camera, infrared scanner, and the like. Reader 120 further includes at least one network interface component 128 adapted to communicate with POS 110, transaction processor 130, and/or other devices and servers over network 150. In various embodiments, network interface component 128 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices.

Transaction processor 130 may be maintained, for example, by an online service provider, which may provide processes to provide merchant, user, and account services to process payments for transactions, and well as provide additional computing services. In this regard, transaction processor 130 includes one or more processing applications which may be configured to interact with POS 110, reader 120, and/or another device/server to facilitate communications and transactions between users. Transaction processor 130 may be maintained by or include another type of platform or service provider, for example, a transaction processor such as PAYPAL®, Inc. of San Jose, CA, USA. Although transaction processor 130 and reader 120 are discussed as separate devices and servers, in some embodiments, one or more of the described processes of may instead be provided by the other device or server, or the same device or server.

Transaction processor 130 of FIG. 1 includes a reader connectivity platform 140, a transaction processing application 132, a database 134, and a network interface component 138. Reader connectivity platform 140 and transaction processing application 132 may correspond to executable processes, procedures, and/or applications with associated hardware. In other embodiments, transaction processor 130 may include additional or different modules having specialized hardware and/or software as required.

Reader connectivity platform 140 may correspond to one or more processes to execute modules and associated specialized hardware of transaction processor 130 to facilitate reader and other terminal devices connectivity in order to determine which readers are available to process transactions for items with POS 110 and/or other devices for merchants and merchant locations. In this regard, reader connectivity platform 140 may correspond to specialized hardware and/or software used by merchants, and provided by transaction processor 130 and/or other service providers, to determine statuses of reader 120 and/or other terminal devices. Reader connectivity platform 140 may therefore monitor statuses of readers 141, which may include reader 120 and correspond to those readers that may be connected and/or connectable to different POS devices and to transaction processor 130 over a network or Internet connection, such as bidirectional connections over a cloud computing system and environment.

Initially, when reader 120 is powered on and/or used to connect with POS 110 and/or process transactions with POS 110, reader connectivity platform 140 may establish a connection ID 142 to uniquely identify reader 120 and the established connection with reader 120, which may include and/or correspond to a network address used to communicate with reader via the connection. The connection may correspond to a bidirectional connection established over AWS or the like, and connection ID 142 may identify that connection. Further, connection ID 142 and/or the connection may facilitate communications between POS 110 and reader 120, such as for transaction processing, by routing communications over network 150 using the WebSocket or other connection, which allows for data to be populated on reader 120 for transaction 113, and further allows reader 120 to receive and provide payment data 115 to transaction processor 130 for processing transaction 113. Connection ID 142 may be stored to a database, such as database 134, or a cloud storage database, server database or cache, or other internal or external data storage system, which may then be accessed and used for later communication with reader 120. Thereafter, when a POS transaction request 143 may be received from POS 110 for transaction 113, context ID 144 may be generated by reader connectivity platform 140 to uniquely identify that interaction and the context of the request from POS 110. Context ID 144 may therefore be linked to POS 110 and transaction 114 for POS transaction request 143.

Reader connectivity platform 140 may then determine status 146 of reader 120, such as offline and unavailable or online and available or the like for receipt and processing of payment data 115. In this regard, a message 145 may be generated to ping or message reader 120 with an acknowledgement request to send back a message or other acknowledgement that reader 120 is online and available. Message 145 may therefore identify reader 120 and include context ID 144 so that a received acknowledgement may be tracked with POS transaction request 143 and identify status 146 of reader 120 to POS 110 when processing transaction 113. Message 145 may be transmitted to reader 120, such as by looking up or determining the network address and/or connection of reader 120 with transaction processor 130 over network 150 and/or the cloud computing environment using connection ID 142. Context ID 144 may also be stored to database 134 of a cloud-bases storage for tracking of message 145, as well as processing of transaction 113, and determination of whether reader 120 acknowledges message 145.

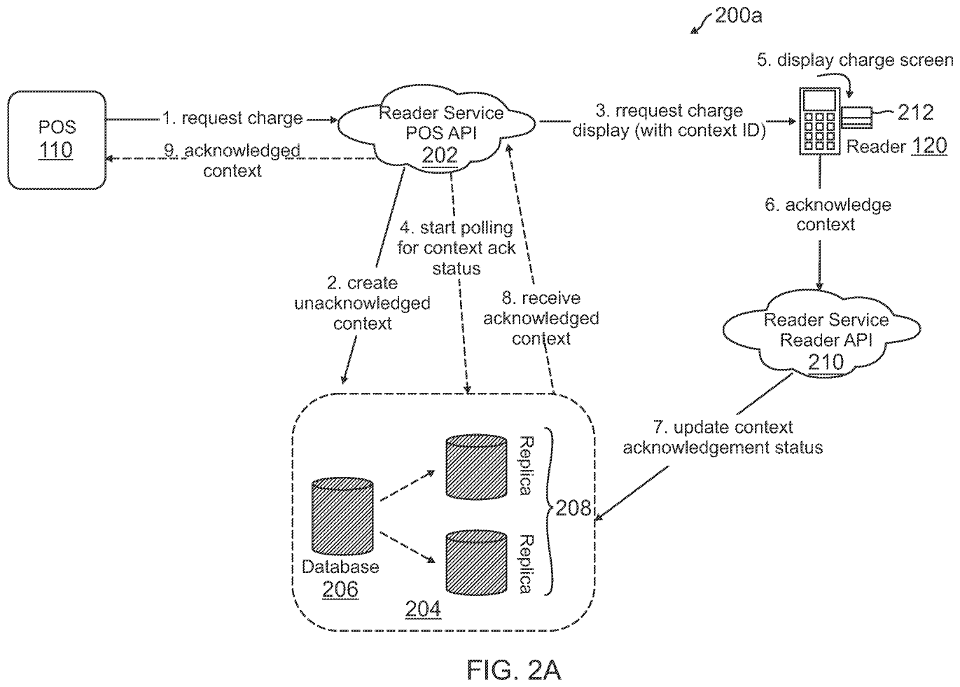

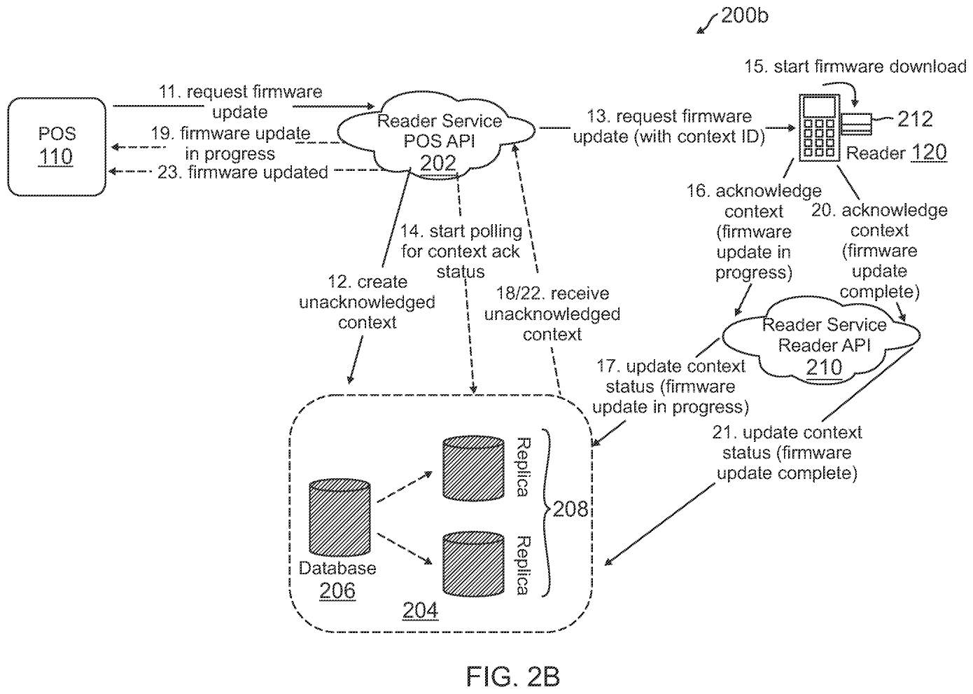

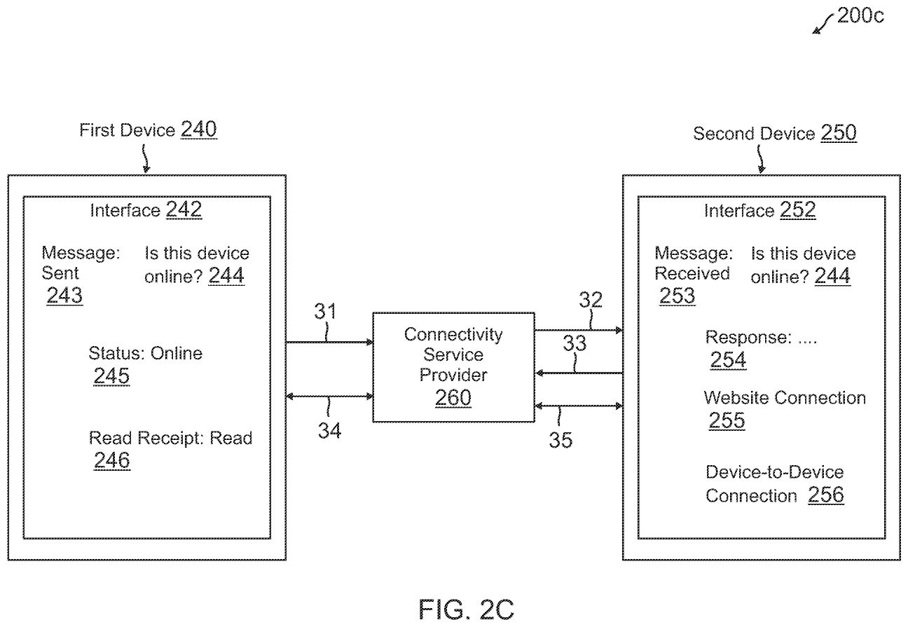

A process, operation, or polling event(s) may be setup and established such that reader connectivity platform 140 may await acknowledgement 125 from reader 120 over a period of time. For example, when reader 120 responds with acknowledgement 125, acknowledgement 125 may be sent over the connection to the cloud computing system where a cloud processor may process and store acknowledgement in association with context ID 144. As such, the process may monitor for acknowledgement 125 from reader 120, which may include polling, listening, and/or checking for acknowledgement 125 in the corresponding database that has been stored and/or processed in association with context ID 144. If received during the period of time, status 146 may be updated to reflect reader 120 is online and/or available. However, if the period of time expires and acknowledgement is not received and/or detected as stored in association with context ID 144, status 146 may reflect that message 145 was not acknowledged and reader 120 is offline and/or unavailable. Examples of such identifiers, components, and operations to determine reader availability are further discussed with regard FIGS. 2A-4 below.

Transaction processing application 132 may correspond to one or more processes to execute modules and associated specialized hardware of transaction processor 130 to process transaction 113 and/or provide another service to customers, merchants, and/or other end users and entities of transaction processor 130. In this regard, transaction processing application 132 may correspond to specialized hardware and/or software used by transaction processor 130 to providing computing services to users, which may include electronic transaction processing and/or other computing services, such as those associated with determining statuses of payment terminal devices and the like. In some embodiments, transaction processing application 132 may be used by users to establish user and/or payment accounts, as well as digital wallets, which may be used to process transactions. Accounts may be accessed and/or used through one or more instances of a web browser application and/or dedicated software application and engage in computing services provided by transaction processing application 132. Transaction processing application 132 may also or instead correspond to messaging, social networking, media posting or sharing, microblogging, data browsing and searching, online shopping, and other services available through transaction processor 130.

Transaction processing application 132 may receive the transaction data for transaction 113 processed using the account accessible through POS 110 and/or other devices or servers. Transaction processing application 132 may determine whether transaction 113 complies with the spending limit(s), rules, permissions, risk, and the like, for processing transaction 113. If so, the transaction may be approved or authorized. However, if the transaction does not comply with the spending limit or exceeds risk for approval of electronic transaction processing and/or credit/balance limit, transaction processing application 132 may be used to decline transaction processing or instruct a backend credit processor to decline processing of the transaction. Transaction 113 may be processed using payment data 115 and results 116 may be provided based on this processing. Further, Transaction processing application 132 may transmit a message including results 116 to POS 110 and/or another device to notify the user of approval or denial of 113 transaction.

In various embodiments, other applications may be desired in particular embodiments to provide features to transaction processor 130. For example, the other applications may include security applications for implementing server-side security features, programmatic client applications for interfacing with appropriate application programming interfaces (APIs) over network 150, or other types of applications. The other applications may contain software programs, executable by a processor, including a graphical user interface (GUI), configured to provide an interface to the user when accessing transaction processor 130 via one or more of POS 110, where the user or other users may interact with the GUI to view and communicate information more easily. In various embodiments, the other applications may include additional connection and/or communication applications, which may be utilized to communicate information to over network 150.

Additionally, transaction processor 130 includes or may access database 134 or other type of data storage system and/or component(s). Database 134 may correspond to a single or distributed database, a cloud-based storage, a cache, or another internal or external data storage system. Database 134 may store various identifiers associated with POS 110. Database 134 may also store account data, including payment instruments and authentication credentials, as well as transaction processing histories and data for processed transactions. Database 134 may store received data associated with a user, such as transaction data for electronic transaction processing. Further, database 134 may be used to store reader IDs 136, such as connection and context IDs. Although database 134 is described as an internal database, cache, or other data storage system, database 134 may also be accessible from an external and/or cloud-based system. As such, in some embodiments, database 134 may be provided by another platform and may be accessible for storage and lookup of connection and context IDs, such as a cloud-based data storage system (e.g., data lake or repository where data may be streamed, stored, and/or processed for availability with different customers, tenants, and other affiliated entities of the cloud computing system for the cloud-based storage).

In various embodiments, transaction processor 130 includes at least one network interface component 138 adapted to communicate with POS 110, reader 120, and/or another device/server over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

FIGS. 2A-2C are exemplary system environments 200a-200c of different devices and servers interacting to provide an acknowledgement process of receipt of message transmissions and message processing, according to an embodiment. System environments 200a-200c of FIGS. 2A-2C correspond to operational flows and data communications between devices, servers, and/or systems when interacting to detect a status of a terminal device when requested to process data by a primary device, such as interactions between POS 110, reader 120, and/or transaction processor 130 discussed in reference to system 100 of FIG. 1.

In system environment 200a of FIG. 2A, interactions to detect availability of a payment terminal device, such as reader 120, for use during payment processing is shown, such as to process a charge for a transaction using payment data entered at such terminal device. To begin at an interaction 1, POS 110 requests a charge to a reader service POS API 202, which may correspond to a publicly exposed API of a service provider, such as a transaction processor. For example, when processing transactions, POS 110 may utilize reader service POS API 202 to exchange API calls to the transaction processor necessary for processing a transaction using reader 120 and the electronic transaction processing services (e.g., different applications, decision and/or microservices, artificial intelligence (AI) models and engines including machine learning (ML) models and/or neural networks (NNs)) provided by the transaction processor. Reader service POS API 202 may correspond to a GraphQL API (e.g., an API coded for use of Graph QL as the data query and manipulation language), which may utilize GraphQL to exchange API calls. This may allow API requests and other calls for queries to reader service POS API 202 to utilize GraphQL, which may allow for POS 110 and/or other devices to specify data for return from reader service POS API 202. However, other syntaxes and languages may also be utilized for reader service POS API 202.

At an interaction 2, an unacknowledged context is created in a cloud computing environment 204, such as in a database 206 that may have replicas 208 reproduced in the cloud and/or at the transaction processor when utilizing cloud computing environment 204. The unacknowledged context may correspond to a context ID specifically identifying interaction 1, the requested charge, and/or the corresponding transaction. The context ID may be generated and stored in database 206 and/or replicas 208 in order to track processing of the transaction, and specifically whether reader 120 is responsive to an acknowledgement request to identify reader 120 as online (or other status indicating good working order and availability). Database 206 and/or replicas 208 may correspond to Amazon DyanmoDBs®, such as for AWS that may be used for cloud computing environment 204, such as for a NoSQL database and key-value datastore. However, other databases and database types may also be used.

At an interaction 3, an acknowledgement request is sent to reader 120 from reader service POS API 202, which may correspond to a request to display the charge on reader 120 (e.g., initiate transaction processing for the transaction by displaying charge amount, items, transaction information, etc.). The request and/or charge may be sent by looking up a previous WebSocket or other connection, such as by used a previous connection ID used to establish and/or created from establishment of the connection, stored by reader service POS API 202 when reader 120 was connected with reader service POS API 202, such as by using cloud computing environment 204. As such, the connection ID may be stored by database 206 and/or replicas 208, which may allow lookup of this bidirectional connection or the like that was previously established on wakeup, connectivity, activation, and/or use of reader 120 with POS 110.

The request and/or charge may be accompanied by the context ID and may request and/or require reader 120 to respond with an acknowledgement, thereby confirming availability. Substantially simultaneously and/or within a time period, at an interaction 4, reader service POS API 202 may establish an acknowledgement process for detection of the acknowledgement from reader 120. This process may correspond to one where reader service POS API 202 polls, monitors, checks, and/or listens for the acknowledgement from reader 120, which may therefore create or initiate the process at reader service POS API 202 and/or with cloud computing environment 204.

At an interaction 5, reader 120 may receive the charge display request and/or acknowledgement request with the context ID, and may perform an operation to display a charge screen and/or interface having the transaction details to a customer or other user. This may provide a charge total for the transaction and instructions on how to proceed with the transaction. Reader 120 may further respond to a reader service reader API 210 at an interaction 6 with an acknowledgement of the context ID, which may correspond to another API of the transaction processor or other service provider configured to interface and exchange API calls with readers and other payment terminal devices or the like for status determination. This may similarly be a GraphQL API or API using another query language for query and/or call construction. As such, the acknowledgement may be provided to reader service reader API 210 to identify reader 120 as online and available to process the charge and transaction using a payment instrument. Reader 120 may then be used to read a payment instrument 212 for the charge and engage in transaction processing.

At an interaction 7, reader service reader API 210 may the store the acknowledgement from reader 120 in database 206 and/or replicas 208 with cloud computing environment 204 in association with the context ID, such as by writing the acknowledgement to the corresponding database with the context ID. As such, during an interaction 8, the polling event or other acknowledgement process by reader service POS API 202 may then return a positive result from monitoring, polling, or listening over the time period for the acknowledgement being received in association with the context ID (e.g., by detecting a stored acknowledgement for the context ID). Reader service POS API 202 may therefore receive the acknowledged context, which may indicate that reader 120 is online. At an interaction 9, reader service POS API 202 then responds to POS 110 with the acknowledged context, such as by respond to POS 110 with a status update or notification that reader 120 is online. This acknowledged context to POS 110 may include the context ID so that POS 110 may use the context ID to track charge and transaction processing.

In system environment 200b of FIG. 2B, interactions to detect availability of a secondary device, such as reader 120, for performing a firmware update based on a request by a primary device are shown. The interactions in system environment 200b may be performed similarly to those in system environment 200a, however, with regard to performing a firmware update at reader 120 or another secondary device when request by POS 110 or other primary device. As such, similar GraphQL APIs, DynamoDBs, cloud computing environments, and/or exchanged calls may be used or other similar embodiments of such APIs, databases, and API calls. The interactions in system environment 200b may be used so that a primary device may detect when a firmware update has actually begun and/or when the firmware update is completed on a secondary device, which normally is not known or transparent. As such, the primary device may, during conventional firmware update processes, not know when the secondary device is updated with new firmware and available. In contrast, the interactions in system environment 200b may facilitate the primary device in this determination and information to allow for continued use based on the status of the secondary device. In system environment 200b, the primary device may correspond to POS 110 and the secondary device may correspond to reader 120.

In system environment 200b, POS 110 requests a firmware update of reader 120 at interaction 11, such as in a similar manner to requesting a charge at reader 120. As such, reader service POS API 202 may be called through an API call and exposed public API that allows for devices to call such services and systems for determining a status and performing a firmware update of reader 120. In this regard, reader service POS API 202 creates the unacknowledged context at interaction 12 with database 206 and/or replicas 208, such as by creating and/or storing a context ID for the firmware update in database 206 and/or replicas 208 with cloud computing environment 204. In a similar manner, reader service POS API 202 further requests the firmware update with context ID to reader 120 at an interaction 13, which causes reader service POS API 202 to create and/or initiate the acknowledgement process for polling or otherwise monitoring and checking cloud computing environment 204 (and specifically database 206 and/or replicas 208) for the context ID and corresponding acknowledgement at an interaction 14.

At an interaction 15, reader 120 begins or initiates the firmware update, thereby acknowledging that reader 120 is online, active, and performing the firmware update ensuring that the firmware update with proceed. In response to starting and/or performing the firmware update, reader 120 provides a context acknowledgement to reader service reader API 210, such as by responding with an acknowledgement and the context ID so that, at an interaction 17, reader service reader API 210 provides the updated context status (e.g., that the firmware update has started and/or is in progress) to cloud computing environment 204 for storage by database 206 and/or replicas 208.

At an interaction 18, reader service POS API 202 may then detect that the acknowledgement for the context ID is received, and may therefore determine that reader 120 is updating its firmware. Thereafter, reader service POS API 202 may inform POS 110 that the firmware update is in progress at an interaction 19, and therefore the status of reader 120 is “updating,” which may indicate that reader 120 is temporarily unavailable while updating. At an interaction 20, reader 120 may complete the firmware update and may respond as such to reader service reader API 210 with the “update complete” status for the firmware update. The updated status by reader 120 may be accompanied by the context ID for status tracking, which allows reader service reader API 210 to provide the updated context status to cloud computing environment 204 for storage with database 206 and/or replicas 208 in association with the context ID, at an interaction 21. This allows reader service POS API 202 to receive the new status of reader 120 from the acknowledgement process that indicates reader 120 has completed updating and is online or available again, as well as updated, at an interaction 22. At an interaction 23, reader service POS API 202 then responds to POS 110 with the new status that the firmware of reader 120 is updated and reader 120 is online, available, or the like.

In system environment 200c of FIG. 2C, interactions to detect messaging receipt by a receiving device (e.g., reader 120) when sent by a sender device (e.g., POS 110) using a service provider server (e.g., transaction processor 130) is shown. System environment 200c shows interactions that may be performed in order for a first device to receive a status and acknowledgement of a sent message, such as to receive a read receipt. This may be utilized in communication and/or messaging systems between users, as well as emergency or other device-to-device interactions requiring message acknowledgement. As such, system environment 200c includes a first device 240 and a second device 250, where first device 240 may correspond to POS 110 and second device 250 may correspond to reader 120.

In system environment 200c, first device 240 includes an interface 242 where a sent message 243 is input and transmitted to second device 250 that includes a message content 244 (e.g., “Is this device online?”). Sent message 243 may be transmitted to a connectivity service provider 260, such as transaction processor 130 utilizing a cloud computing environment to facilitate communication, at an interaction 31. Connectivity service provider 260 may then transmit message content 244 and other message data for sent message 243 to second device 250 at an interaction 32. This may include establishing a context ID in a database and an acknowledgement process to detect when an acknowledgement of sent message 243 is received from second device 250.

Second device 250 includes an interface 252, which may be used to display received messages, such as a received message 253 corresponding to sent message 243 from interface 242 of first device 240. Interface 252 may be used to read message content 244, which may similarly display “Is this device online?” and may allow for entry of a response 254. By receiving and/or displaying message content 244 in received message 253, as well as entering response 254, second device 250 may provide an acknowledgement with the context ID back to connectivity service provider 260 at an interaction 33. This may be stored to a database with the context ID such that the acknowledgement process by connectivity service provider 260 may identify the acknowledgement and respond, at an interaction 34, to first device 240 acknowledging that sent message 243 was received by second device 250 and message content 244 populated in interface 252 with received message 253. As such, at interaction 34, status 245 may be updated to online and a read receipt 246 may indicate that message content 244 was read. At an interaction 35, second device 250 may provide response 254, such as over bidirectional connection 255 to connectivity service provider 260, which may also be facilitated by device-to-device connection 256 for direct data transfers when device activity and status has been confirmed.

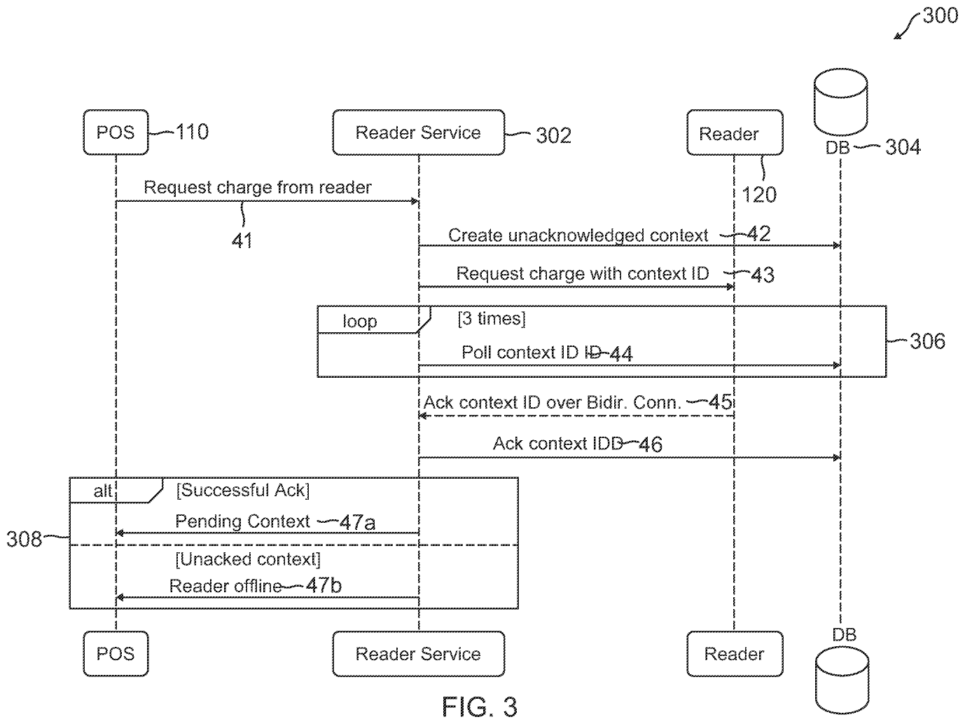

FIG. 3 is an exemplary diagram 300 of exchanged API calls and message transmissions for acknowledging a message transmission by a terminal device with a backend server for notifying a POS or other device of the terminal device's status, according to an embodiment. Diagram 300 of FIG. 3 includes a representation of the exchanged API calls, data processing events, and/or other messages and data processing that occurs between devices, services, and databases that may be used to identify a status of reader 120 from system 100 of FIG. 1. In this regard, such interactions may be performed by POS 110, and reader 120 with a reader service 302 and a database 304 that may correspond to transaction processor 130 and/or a cloud environment and/or system utilized by transaction processor 130, which are discussed in reference to system 100.

In diagram 300, the process for acknowledging a request and/or message from transaction processor 130 by reader 120 is shown in further detail. Initially, POS 110 may communicate with reader service 302 when a transaction occurs, where a charge for the transaction may be requested from reader 120 at an interaction 41. For example, once a transaction is generated at POS 110, POS 110 may request for reader 120 to charge a customer and receive/process payment data entered at reader 120 by the customer. Reader service 302 may correspond to an application, computing service, and/or components, including those associated with a corresponding cloud computing environment, which may manage different readers, payment terminal devices, and/or other devices configured to interact with POS 110 and/or similar devices, such as to facilitate processing of data and/or exchange of messages. In this regard, reader service 302 may be provided by transaction processor 110 and/or in a cloud environment, and may further utilize database 304 for storage of connection IDs, context IDs, and acknowledgement messages and responses during status determination of different readers and terminal devices.

At an interaction 42, an unacknowledged context for the charge requested by the reader by POS device is generated by reader service 302 and stored by database 304. The unacknowledged context may correspond to a context ID that has not had an acknowledgement response from reader 120 and is stored while awaiting such a response so that the unacknowledged context may be polled when determining a status of reader 120. At an interaction 43, a request or other message is transmitted from reader service 302 to reader 120, which, in some embodiments, may include requesting that reader 120 initiate the charge and request payment from the customer. The request may include a command or operation that cause reader 120, when online, receiving the request, and/or available, to respond with an acknowledgement, which may be stored by database 304.

In this regard, a polling event or other monitoring for an acknowledgement process 306 is initiated and established at an interaction 44, where a loop or other periodic/continuous process to check database 304 for the acknowledgement is performed. In this regard, at substantially the same time or during this process, reader 120 may respond and acknowledge the context ID over a bidirectional connection or the like to reader service 302 at an interaction 45. This may occur during the time period for acknowledgement process 306 such that acknowledgement process 306 may detect the acknowledgement, which may identify reader 120 as online and available. However, interaction 45 may not occur if reader 120 is offline, and thus the time period of acknowledgement process 306 to check for the acknowledgement at interaction 44 may end without detecting the acknowledgement, which may cause reader service 302 to notify POS 110 that reader 120 is offline and/or unavailable. As such, an interaction 46 may occur after interaction 45 where acknowledgement process 306 positively identifies the acknowledgement of the context ID by reader service 302 from database 304.

As such, a status update 308 may depend on a whether an acknowledgement is detected during interaction 44 from acknowledgement process 306, such as if interaction 45 occurs and reader 120 responds and acknowledges the context ID. As such, for an interaction 47a during status update 308, reader service 302 may transmit a successful acknowledgement and therefore available status of reader 120 to POS 110 if interaction 45 occurs and acknowledgement process 306 detects the acknowledgement to the context ID in database 304. However, if interaction 45 does not occur, then during status update 308, an interaction 47b occurs where POS 110 is notified by reader service 302 of the unacknowledged context ID and that reader 120 is offline.

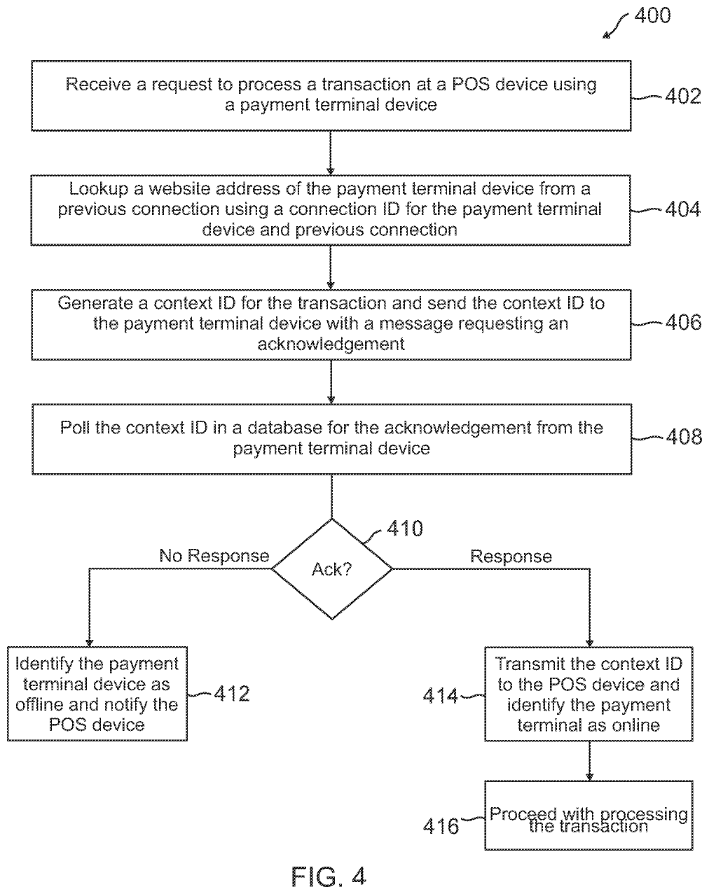

FIG. 4 is a flowchart 400 of an exemplary process for an acknowledgement process for message transmissions to connectable processing terminals for POS devices, according to an embodiment. Note that one or more steps, processes, and methods described herein of flowchart 400 may be omitted, performed in a different sequence, or combined as desired or appropriate.

At step 402, a request to process a transaction at a POS device using a payment terminal device is received. For example, a merchant may enter transaction data for a transaction to a POS device and/or a customer or other user may provide items and/or enter the data using the POS device (e.g., by scanning items, entering item codes or identifiers, selecting items in a menu, etc.). Once a transaction is created, the POS device may initiate a transaction and payment processing so that a payment may be received for the transaction and the transaction may be approved, or conversely declined if such payment is not processed. This causes the POS device to communicate with a transaction processor, as well as initiate a process to use a payment terminal device, such as a reader that may scan or read payment cards and/or mobile smart phone data.

At step 404, a WebSocket address, or similar network and/or device address, of the payment terminal device is looked up from a previous connection using a connection ID for the payment terminal device and previous connection. The payment terminal device may have a separate Internet connection to the transaction processor, which may be facilitated by a cloud computing system and processors, such as by connecting with the transaction processor using AWS or the like over a bidirectional connection or the like. Such connection may cause generation of a connection ID, which may uniquely identify this bidirectional connection, for example, by identifying the connection and/or a network address (e.g., WebSocket address) of the payment terminal device.

At step 406, a context ID is generated for the transaction and sent to the payment terminal device with a message requesting acknowledgement. In order to uniquely identify the transaction and request for the payment terminal device to acknowledge a message and be online and/or available for processing the transaction, a particular ID may be generated to uniquely identify such data and requests. The context ID may therefore be used to track interactions and whether the payment terminal device is online and available when an acknowledgement is received from the payment terminal device to a request from the transaction processor over the connection (e.g., bidirectional connection, which may be transmitted using the connection ID). The context ID may be stored in a database, such as one associated with the cloud computing environment facilitating the connection between the transaction processor and/or over the cloud network and system with the payment terminal device. Thereafter, the message and/or request may be created to cause the payment terminal device to acknowledge the message/request and respond in association with the context ID.

At step 408, the context ID is polled in a database for the acknowledgement from the payment terminal device. A polling, monitoring, listening, and/or tracking process may be created, initiated, and/or started on transmission of the message/request for the acknowledgement, which may be used to check the context ID in the database to determine if an acknowledgement have been received. This process may continue to check, continuously or at periodic intervals, for the acknowledgement over a period of time, which may be initiated by the service provider with the cloud computing system. At step 410, it is determined whether the acknowledgement is received. This may be done by monitoring and/or polling the database for the response.

At step 412, if no response and acknowledgement is received, the payment terminal device is identified as offline, and the POS device is notified of such status. In this regard, the payment terminal device may be identified as offline and unavailable if no acknowledgement is received and detected (e.g., as stored in the database and/or in association with the context ID) by the expiration of the period of time. As such, the transaction processor may determine that the payment terminal device is offline or otherwise unavailable and notify the POS device as such so that a different payment terminal device may be used to process payment data and other information with the customer.

At step 414, if a response and acknowledgement is received, the payment terminal device is identified as online, and the POS device is notified of such status and the context ID is transmitted to the POS device. In this regard, if an acknowledgement of the transmitted message is detected in the database and/or associated with the context ID during the period of time for the polling event and/or process, then the payment terminal device may be identified as online and available to be used with the POS device. The transaction processor may then notify the POS device with the context ID so that the context ID may then be used to track processing of the transaction. At step 416, the transaction may be processed, such as by using input from the payment terminal device. As such, the transaction may be processed with input payment data, such as a scanned card or received token, which may be associated with the context ID now available with the POS device and payment terminal device so that correlations may be made between the data and tracked during processing.

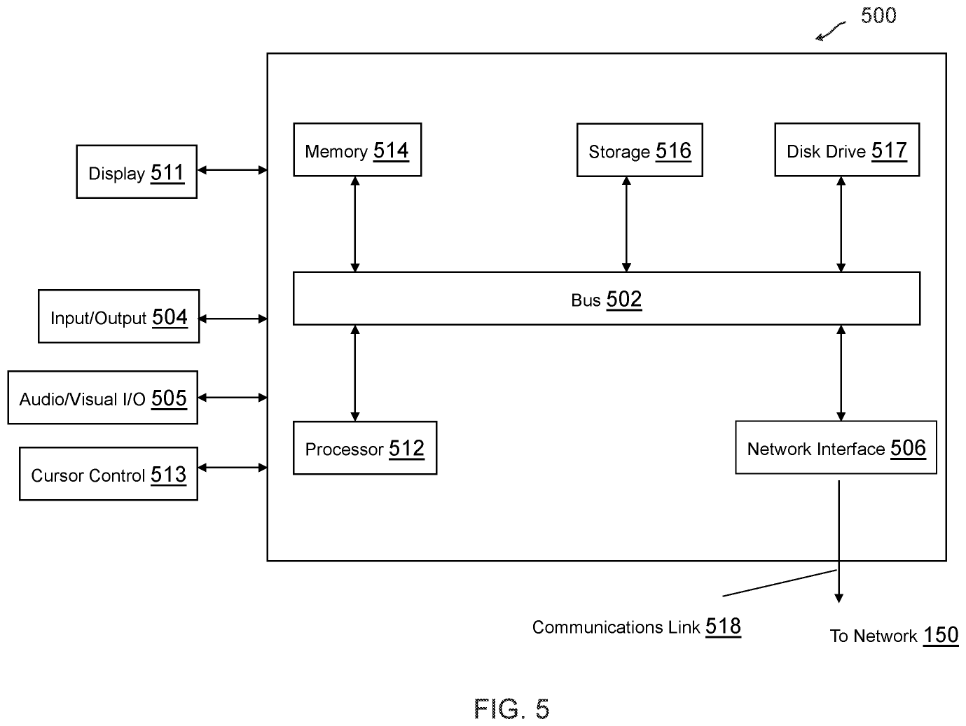

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving, from a point-of-sale (POS) device, a request to process a transaction from the POS device, wherein the transaction is being processed at the POS device using a payment terminal device connectable to the POS device;
determining, using a connection identifier (ID) associated with the payment terminal device, a network address of the payment terminal device;
transmitting a message to the payment terminal device using the network address, wherein the message comprises a context ID associated with the transaction that is stored by a database accessible by at least the system and the payment terminal device, and wherein the message requests an acknowledgement message from the payment terminal device that is responsive to the message and indicates the payment terminal device is online and connected to the POS device;
establishing an acknowledgement process that polls the database for the acknowledgement message for the context ID from the payment terminal device;
polling, using the acknowledgement process and the context ID, the database over a period of time for the acknowledgement message; and
notifying the POS device of a status of the payment terminal device based on whether the acknowledgement message for the context ID is received during the period of time.

2. The system of claim 1, wherein, prior to the notifying, the operations further comprise:
determining, based on the polling, that the acknowledgement message and the context ID were not provided by the payment terminal device during the period of time; and
updating the status to indicate, to the POS device, that the payment terminal device is offline and unusable for processing of the transaction.

3. The system of claim 1, wherein, prior to the notifying, the operations further comprise:
receiving, based on the polling, the acknowledgement message and the context ID during the period of time; and
updating the status to indicate, to the POS device, that the payment terminal device is online and to proceed with processing of the transaction using the payment terminal device.

4. The system of claim 3, wherein, prior to the transmitting the message, the operations further comprise:
generating the context ID for the transaction based on at least one of the request or the payment terminal device,
and wherein, after the notifying the POS device of the status, the operations further comprise:
returning the context ID to the POS device with a processing result of the transaction.

5. The system of claim 4, wherein the context ID is returned after the system processes the transaction and generates the processing result, and wherein the context ID correlates the transaction with transaction processing events between the system, the POS device, and the payment terminal device stored by the database.

6. The system of claim 1, wherein the connection ID is established on a connection of the payment terminal device to the POS device and a creation of a bidirectional connection by the payment terminal device with the system, and wherein the network address comprises a WebSocket address associated with the bidirectional connection between the payment terminal device and the system.

7. The system of claim 6, wherein the bidirectional connection is established and managed using an on-demand cloud computing platform, and wherein the database comprises a NoSQL database associated with the on-demand cloud computing platform and using a GraphQL API.

8. The system of claim 1, wherein the period of time is based on a set number of polling events for the polling, each of the set number of polling events performed at a set time interval, and wherein the polling over the period of time concludes after a last one of the set number of polling events.

9. The system of claim 1, wherein the acknowledgement message is required prior to a processing of the transaction via the payment terminal device, and wherein the processing of the transaction utilizes the context ID to correlate data received by the payment terminal device to data received by the POS device.

10. The system of claim 1, wherein the operations further comprise:
receiving the acknowledgement message and the context ID during the period of time;
determining, by a terminal management service responsive to the receiving the acknowledgement message and the context ID, that a firmware update of the payment terminal device is available;
executing the firmware update with the payment terminal device; and
tracking a completion of the firmware update using the context ID and a bidirectional connection established using the connection ID.

11. The system of claim 1, wherein the operations further comprise:
causing the POS device to initiate a customized prompt flow on the payment terminal device based on the status;
tracking the status of the payment terminal device during the customized prompt flow using a bidirectional connection associated with the connection ID; and
automatically updating the status of the payment terminal device on the POS device during the customized prompt flow.

12. A method comprising:
receiving, from a point-of-sale (POS) device, a connection request with a payment terminal device by the POS device for processing a transaction at the POS device using payment data entered to the payment terminal device;
retrieving a connection identifier (ID) and a network address for a connection established with the payment terminal device using the connection ID;
pinging the payment terminal device with an acknowledgement request message using the network address, wherein the acknowledgement request message comprises a context ID associated with the transaction and requests that the payment terminal device respond with an acknowledgement message that indicates that the payment terminal device is online and connectable to the POS device;
initiating an acknowledgement process that monitors for the acknowledgement message from the payment terminal device;
monitoring, using the acknowledgement process, the database over a period of time for the acknowledgement message associated with the context ID; and
providing, over the period of time, a status of the payment terminal device based on whether the acknowledgement message is received during the period of time, wherein the status indicates whether the payment terminal device is online and connectable to the POS device.

13. The method of claim 12, wherein the status indicates whether the payment terminal device is online and available for processing a charge for the transaction from the POS device.

14. The method of claim 13, wherein the charge is received with the connection request based on the transaction, and wherein the payment data is entered at the payment terminal device for processing the charge by a transaction processor.

15. The method of claim 12, wherein the connection request is received from the POS device based on the POS device requesting that a firmware update be performed with the payment terminal device.

16. The method of claim 15, wherein the acknowledgement message indicates that the firmware update has been started with the payment terminal device, and wherein the method further comprises:
monitoring, using the acknowledgement process, the database over the period of time for a further acknowledgement message indicating that the firmware update has completed; and
updating the status based on whether the further acknowledgement message is received during the period of time.

17. A method comprising:
receiving, by a service provider from a first device, a request from the first device for a status of a second device, wherein the status indicates whether the second device is online and connectable by the first device for a message exchange;
determining a network address of the second device;
transmitting a first message to the second device using the network address, wherein the first message comprises a context ID associated with the request that is stored by a database accessible to at least the service provider and the first device, and wherein the first message requests an acknowledgement from the second device that is responsive to the first message and indicates the second device is online;
establishing an acknowledgement process with the service provider that checks for the acknowledgement for the context ID from the second device over a period of time; and
notifying the first device of the status of the second device based on whether the acknowledgement for the context ID is received during the period of time.

18. The method of claim 17, wherein the request for the status is received with a second message designated for an application on the second message and including message content requesting a confirmation of receipt of the second message, and wherein the first message is transmitted responsive to receiving the second message.

19. The method of claim 18, wherein the confirmation is requested based on one of a read receipt request or an emergency messaging requirement.

20. The method of claim 17, wherein the request is received based on a firmware update for the second device, and wherein the acknowledgement includes an indication of whether the firmware update is one of initiated on the second device or completed on the second device.
